(19) United States
(12) Patent Application Publication
(10) Pub. No.: US 2009/0051228 A1
(43) Pub. Date: Feb. 26, 2009

(54) ACTUATOR UNIT

(75) Inventors: Masahiro Kanbara, Tokyo (JP); Takuya Shirata, Tokyo (JP); Junichiro Asano, Tokyo (JP); Masayuki Togawa, Tokyo (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: NABTESCO CORPORATION, Minato-ku, Tokyo (JP)

(21) Appl. No.: 11/908,803

(22) PCT Filed: Mar. 29, 2006
(86) PCT No.: PCT/JP2006/306546

§ 371 Date: Sep. 17, 2007

(30) Foreign Application Priority Data
Mar. 30, 2005 (JP) P2005-097958

(51) Int. Cl. H02K 41/035

(52) U.S. Cl. 310/14

(57) ABSTRACT

An actuator unit 100 which moves a light reflection element 32 in a predetermined optical path-switching-position includes a mover 120 to which the light reflection element 32 is fixed, and a fixed part body 110 including an E-shaped yoke 113. When the mover 120 is located at one end in its moving range, the posture of the mover 120 is specified by magnetic attraction forces in two directions orthogonal to each other which are generated between one end portion 113a yoke 113 and an orthogonal part 113c of the E-shaped, and the mover by a permanent magnet 121 and an electromagnet 118, whereby a tilt of the mover 120 can be prevented.

### CROSS-REFERENCE TO RELATED APPLICATIONS

This application is a Section 371 of International Application No. PCT/JP2006/306546, filed Mar. 29, 2006, which was published in the Japanese language on Oct. 12, 2006, under International Publication No. WO 2006/106773 A1 and the disclosure of which is incorporated herein by reference.

### BACKGROUND OF THE INVENTION

The present invention relates to an actuator unit which drives one member in relation to the other member, and particularly to an actuator unit used in an optical device such as an optical switch or the like (i.e., an actuator unit for moving a light reflection element into or out of an optical path of a light signal to switch its optical path.

Heretofore, as an actuator which drives one member in relation to the other member, there has been known an actuator which includes a fixed part body fixed to one member, and a mover that is fixed to the other member and can move in a nearly linear manner in relation to the fixed part body, and which moves the mover in relation to the fixed part body by an electromagnet and a permanent magnet (refer to, for example, Patent Document 1).

An actuator disclosed in this Patent Document 1 is a polar electromagnetic device using an E-shaped yoke as a fixed part body, which is used mainly in a relay of an electric circuit. The present inventor who is finding a suitable actuator as an actuator for an optical switch which does not require specially large force and long stroke has paid attention to this polar electromagnetic device.

Patent Document 1: JP-UM-B-1-10889 (P2, FIG. 1)

When such the polar electromagnetic device using the E-shaped yoke was used as an actuator of an optical switch, some problems were produced. As one of their problems, there was a problem relating to angular accuracy of the moved light reflection element. The light reflection element moved in a predetermined position on the optical path in order to switch the optical path must makes always the same an angle of the light reflection element in its predetermined position to the optical path thereby to prevent an optical axis of the reflection light from shifting. However, the conventional polar electromagnetic devices did not have the structure for movement of such high accuracy as to satisfy its requirement.

### BRIEF SUMMARY OF THE INVENTION

The invention has been made in order to solve the above problem, and has an object to provide an actuator unit for optical switch which can specify an arrangement state of a mover which has been moved thereby to prevent its mover from being arranged in a tilting state. An actuator unit of the invention is used to move an optical-reflective member in relation to an optical path of a light signal, and includes a mover to which the light reflection element is fixed, and a fixed part body which supports this mover movably. The fixed part body has an E-shaped yoke for moving the mover by magnetic force. This E-shaped yoke includes one end portion arranged on one end side in the moving range of the mover; the other end portion arranged on the other end side in its moving range; and an orthogonal part arranged between the one-end portion and the other-end portion, and in a direction nearly orthogonal to the moving direction of the mover. Further, this actuator unit includes an electromagnet and a permanent magnet which are used to move the mover in relation to the fixed part body. The electromagnet is provided for the fixed part body, and magnetized the one-end portion and the other-end portion of the E-shaped yoke, and the orthogonal part with opposite polarities to each other. The permanent magnet is provided for at least either the fixed part body or the mover, and generates magnetic force between the one-end portion and the other-end portion of the fixed part body, and the mover. Further, the fixed part body has a guide part for guiding movement of the mover in the moving range. On the other hand, the mover has a slide part which slides the guide part of the fixed part body.

The actuator unit of the invention, in order to make always constant the angle of the light reflection element moved to the predetermined optical path switching position in relation to the optical path, when the mover is located at one end portion in its moving range, specifies the posture (the arranged state) of the mover. This posture specification of mover is performed by bidirectional magnetic forces generated by the above permanent magnet and/or the electromagnet which are/is provided for the purpose of drive. One of their magnetic forces is first magnetic attraction force which is generated by the permanent magnet between the mover and the one-end portion of the fixed part body. By this first magnetic attraction force (acting in the moving direction of the mover), the mover is pressed against the one-end portion of the fixed part body. The other is second magnetic attraction force generated by the permanent magnet or the electromagnet between the mover and the orthogonal part of the fixed part body. By this second magnetic attraction force (acting in the direction orthogonal to the moving direction of the mover), the slide part of the mover is pressed against the guide part of the fixed part body. These two magnetic forces which urge the mover act in the directions orthogonal to each other, and specify the posture of the mover thereby to suppress a tile of the mover. Hereby, when the mover is located at one end in its moving range, angular accuracy of the light reflection element fixed to the mover in relation to the optical path can be heightened.

More preferably, the slide part of the mover is constituted so that: when the slide part is pressed against the guide part of the fixed part body by the second magnetic attraction force, an imaginary line connecting contact portions of the slide part with the guide part forms a plane (i.e., the slide part and the guide part come into point-contact with each other at three or more positions, or into line-contact with each other at two or more positions. Hereby, by the action of the second magnetic attraction force, the tilt (tilt in the direction orthogonal to the direction of the second magnetic attraction force) of the mover can be suppressed. At this time, the mover, by the first magnetic attraction force in the direction orthogonal to the direction of the second magnetic attraction force, is pressed against the one-end portion of the fixed part body, whereby it is possible to suppress rotation of the mover around an axis extending in parallel to the direction of the second magnetic attraction force. By the action of these bidirectional magnetic attraction forces, when the mover is located at one end in its moving range, it is possible to specify the posture of the mover so that the mover does not tilt in all the directions.

At this time, the guide part provided for the fixed part body extends in the moving direction of the mover and is fixed to the one-end portion and the other-end portion of the fixed part body. Further, the guide part can be provided in two places so as to be arranged on an imaginary plane orthogonal to the direction of the second magnetic attraction force generated between the mover and the orthogonal part of the fixed part body. The slide part of the mover is provided so as to correspond to the guide part located at their two places, and constituted so as to be pressed by the second magnetic attraction force against the both guide parts located at the two places so as to come into contact with the guide parts. The guide part located at the two places can be formed of, for example, two pillar-shaped members parallel to each other. Alternatively, the slide part of the mover is formed of, for example, two pillar-shaped members parallel to each other, and the guide part located at the two places can be also formed so as to support both ends of each pillar-shaped member.

It is preferable that the mover of the actuator unit of the invention has a permanent magnet in its constitution. The permanent magnet provided for this mover generates second magnetic attraction force between the orthogonal part of the fixed part body and the mover. By this constitution, other portions than the permanent magnet of the mover in the actuator unit of the invention can be formed of non-magnetic material. Therefore, compared with the case where all the portions of the mover are formed of magnetic material, the weight of the mover can be reduced. In case that the mover is lightweight, even when force of gravity acts in any direction, the mover operates stably. Therefore, regardless of the mounted posture, the mover can exhibit the stable performance. Further, in the actuator unit of the invention, since both of the first magnetic attraction force and the second magnetic attraction force which suppress the tilt of the mover are generated by the permanent magnet, it is possible to reduce power-application time to the electromagnet thereby to realize power-saving.

The mover having this permanent magnet can be constituted so that: a gap is formed between the permanent magnet and the orthogonal part of the fixed part body in a state where the slide part of the mover is pressed against the guide part of the fixed part body by the second magnetic attraction force; when the mover is located at one end in the moving range of the mover, a gap is formed between the permanent magnet and the E-shaped yoke one-end portion of the fixed part body; and when the mover is located at the other end in the moving range of the mover, a gap is formed between the permanent magnet and the other-end portion of the fixed part body. By this constitution, the actuator unit of the invention can be constituted so that the permanent magnet of the mover is always in non-contact with the E-shaped yoke of the fixed part body. Compared with the constitution in which the permanent magnet is in a contactable state with the E-shaped yoke of the fixed part body, the magnetic force (first magnetic attraction force and second magnetic attraction force) generated between the fixed part body and the mover can be reduced. Accordingly, it is possible to reduce the force required when the mover is moved in relation to the fixed part body (voltage which needs to be applied to the electromagnet).

Further, it is good that at least one member of the contact portion between the fixed part body including the guide part and the mover including the slide part (i.e., at least one of the contact portion of the fixed part body with the mover and the contact portion of the mover with the fixed part body, or at least one of the contact portion of the guide part of the fixed part body with the slide part of the mover and the contact portion of the slide part of the mover with the guide part of the fixed part body) is formed of solid lubricant. Hereby, in the actuator unit of the invention, it is possible to prevent adhesion between the fixed part body and the mover, and even after the actuator unit has been left for a long period, the mover can operate stably. Therefore, even after the actuator unit has been left for a long period, it can exhibit stable performance.

According to the invention, it is possible to provide the actuator unit for optical device such as an optical switch, which specifies the arrangement state of the moved mover thereby to suppress the tilt of the mover.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1A is an external perspective view of an optical switch according to a first embodiment of the invention when a mover of an actuator unit is located on one end portion side of a fixed part body.

FIG. 1B is an external perspective view of the optical switch shown in FIG. 1A when the mover of the actuator unit is located on the other end portion side of the fixed part body.

FIG. 2 is an external perspective view of the actuator unit shown in FIG. 1 when the mover is located on one end portion side of the fixed part body.

FIG. 3 is a top view of the actuator unit shown in FIG. 2.

FIG. 4 is a side view of the actuator unit shown in FIG. 2 when the mover is located on one end portion side of the fixed part body.

FIG. 5A is a sectional view taken along a line I-I in FIG. 3 when electric power is applied to an electromagnet so that magnetic polarity of an orthogonal part becomes N-pole in a state where the mover is located on the other-end portion side of the fixed part body.

FIG. 5B is a sectional view taken along the line I-I in FIG. 3 when electric power is applied to the electromagnet so that magnetic polarity of the orthogonal part becomes S-pole in a state where the mover is located on the one-end portion side of the fixed part body.

FIG. 6A is a sectional view taken along the line I-I in FIG. 3 when electric power is not applied to the electromagnet in the state where the mover is located on the one-end portion side of the fixed part body.

FIG. 6B is a sectional view taken along the line I-I in FIG. 3 when electric power is not applied to the electromagnet in the state where the mover is located on the other-end portion side of the fixed part body.

FIG. 7 is a top view near the mover of the actuator unit shown in FIG. 2.

FIG. 8A is a side view of the optical switch shown in FIG. 1 before the actuator unit is fixed.

FIG. 8B is a side view of the optical switch shown in FIG. 1 after the actuator unit has been fixed.

FIG. 9A is an external perspective view showing an example different from the example shown in FIG. 2 of the actuator unit in the optical switch according to the first embodiment of the invention.

FIG. 9B is a front view of the actuator unit shown in FIG. 9A.

FIG. 10 is an external perspective view of a mover of the actuator shown in FIG. 9.

FIG. 11 is an external view of an actuator unit of an optical switch according to a second embodiment of the invention.

FIG. 12A is a side sectional view of the actuator unit shown in FIG. 11 when electric power is applied to an electromagnet so that magnetic polarity of an orthogonal part becomes S-pole in a state where a mover is located on the other end portion side of a fixed part body.

FIG. 12B is a side sectional view of the actuator unit shown in FIG. 11 when electric power is applied to the electromagnet so that magnetic polarity of the orthogonal part becomes N-pole in a state where the mover is located on one end portion side of the fixed part body.

FIG. 13 is an external view of an actuator unit of an optical switch according to a third embodiment of the invention.

FIG. 14 is an external perspective view of a fixed part body of the actuator unit shown in FIG. 13.

FIG. 15 is an external perspective view of a mover of the actuator unit shown in FIG. 13.

### DETAILED DESCRIPTION OF THE INVENTION

### First Embodiment

Firstly, the constitution of an optical switch according to a first embodiment will be described.

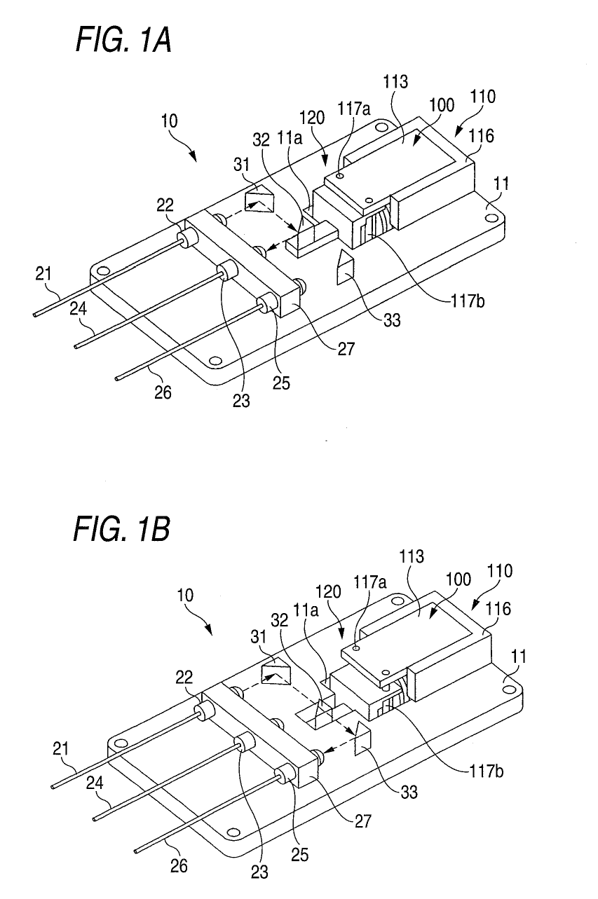

As shown in FIGS. 1A and 1B, an optical switch 10 in this embodiment includes a platform 11 which is a substrate in which a hole 11a is formed; an optical fiber 21 into which light is input from the outside; a lens 22 which collimates the light inputted into the optical fiber 21 and outputs the collimated light; a lens 23 on which light impinges; an optical fiber 24 which outputs the light that has impinged on the lens 23, to the outside; a lens 25 on which light impinges; an optical fiber 26 which outputs the light that has impinged on the lens 25, to the outside; and a lens holder 27 which is fixed onto the platform 11 and holds the lens 22, the lens 23 and the lens 25. The light outputted from the lens 22 is reflected, by a fixed mirror 31 fixed onto the platform 11, toward a movable mirror 32 as a light reflection element. The movable mirror 32 can be moved by an actuator unit 100 in the vertical direction to the upper surface of the platform 11. FIG. 1A shows a state where the movable mirror 32 is arranged on an optical path, and FIG. 1B shows a state where the movable mirror 32 is arranged out of the optical path. In FIG. 1A, the movable mirror 32 reflects the light reflected by the fixed mirror 31, toward the lens 23. On the other hand, in FIG. 1B, the light reflected by the fixed mirror 31 is reflected by the fixed mirror 33 fixed onto the platform 11, toward the lens 25. The actuator unit 100 for driving the movable mirror 32, in a state where a part of the unit 100 is inserted into the hole 11a of the platform 11, is fixed onto the platform 11.

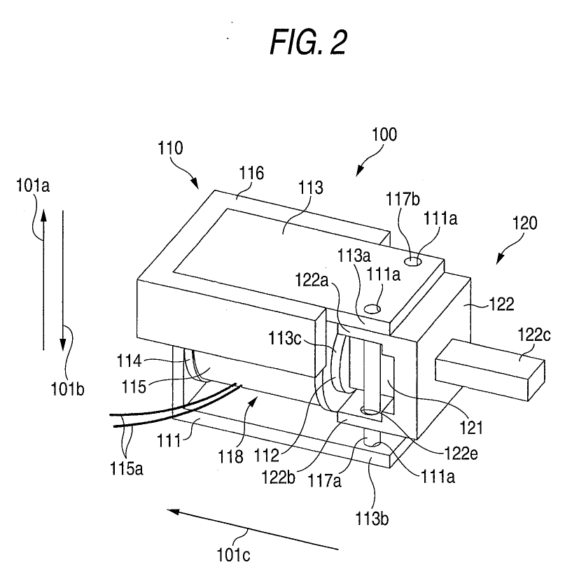

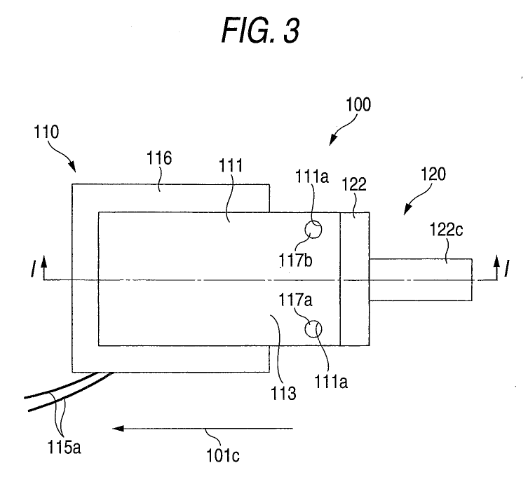

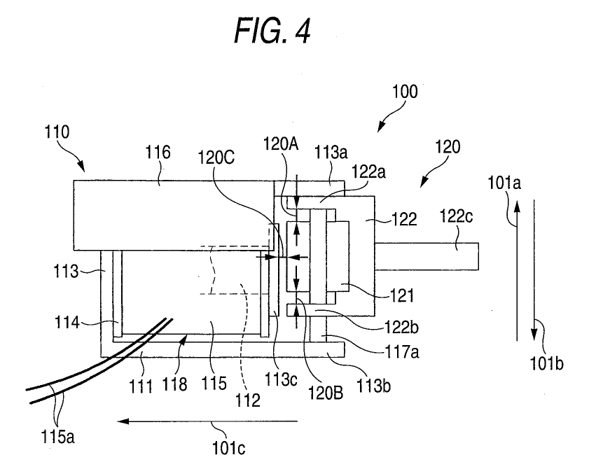

As shown in FIGS. 2 to 4, the actuator unit 100 includes a fixed part body 110 to be fixed onto the platform 11 (refer to FIGS. 1A and 1B), and a mover 120 which has the movable mirror 32 (refer to FIGS. 1A and 1B) fixed thereon and can move linearly in a direction shown by an arrow 101a and in a direction shown by an arrow 101b in relation to the fixed part body 110. In the actuator unit 100, the fixed part body 110 and the mover 120 are integrated.

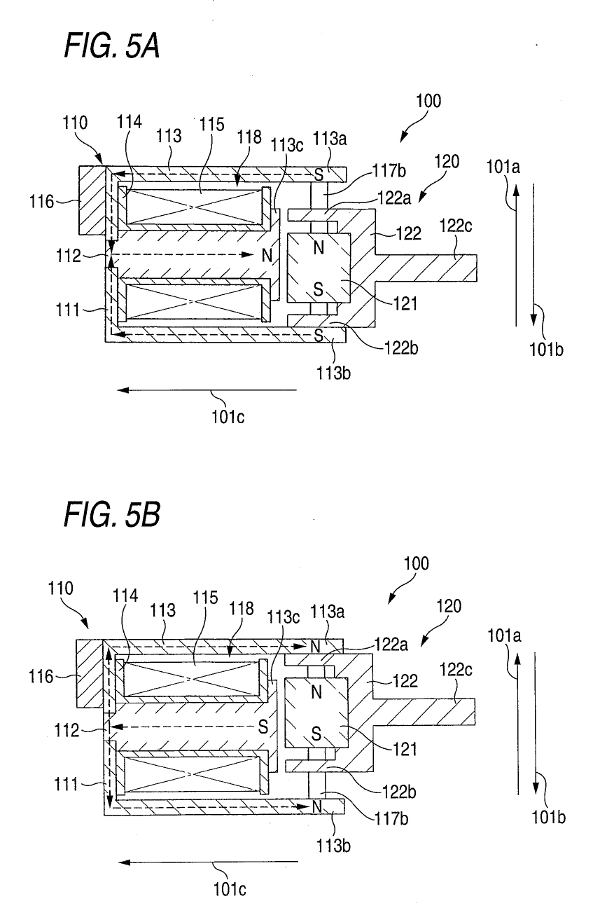

The fixed part body 110 includes a C-shaped member 111 formed of iron (magnetic material); an E-shaped yoke 113 formed of an iron core 112 fixed onto the C-shaped member 111; a bobbin 114 into which the iron core 112 is inserted before the iron core 112 is fixed onto the C-shaped member 111; a coil 115 wound on the bobbin 114; a positioning flange 116 used when the actuator unit 100 is fixed on the platform 11; and two pillars 117a and 117b functioning as a guide part for guiding the movement of the mover 120. Here, the E-shaped yoke 113 has, on the C-shaped member 111, an one-end portion 113a which is arranged on one end side in a moving range of the mover 120 in relation to the fixed part body 110, and an other-end portion 113b which is arranged on the other end side in the moving range of the mover 120 in relation to the fixed part body 110. Further, the E-shaped yoke 113 has, on the iron core 112, an orthogonal part 113c which is arranged in a direction shown by an arrow 101c nearly orthogonal to the moving direction of the mover 120 shown by the arrow 101a in relation to the fixed part body 110, which is shown by the arrow 101a. Further, the iron core 112 and the coil 115 constitute an electromagnet 118 for magnetizing the one-end portion 113a and the other-end portion 113b, and the orthogonal part 113 with opposite polarities to each other as shown in FIGS. 5A and 5B. Further, as shown in FIGS. 2 to 4, the coil 115 has two leads 115a for sending electric current. Further, the flange 116 is fixed to the E-shaped yoke 113. Further, the pillars 117a and 117b extend in parallel to each other in the moving direction of the mover 120 in relation to the fixed part body 110 (direction shown by the arrow 101a), and they are made of non-magnetic material such as ceramic material, for example, alumina zirconia, or the like. These pillars 117a and 117b are inserted respectively into plural holes 111a formed in the one-end portion 113a and the other-end portion 113b of the fixed part body 110 thereby to be fixed to the fixed part body 110.

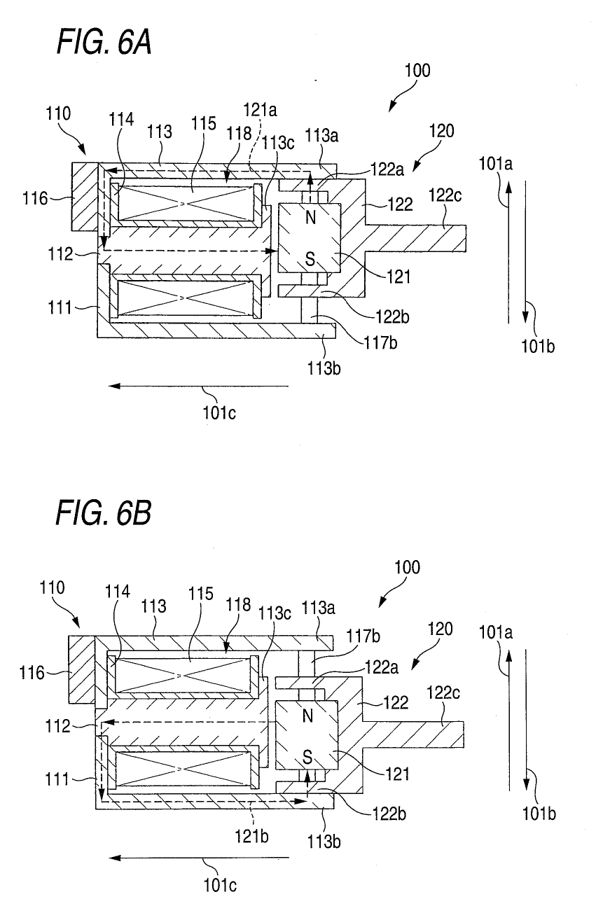

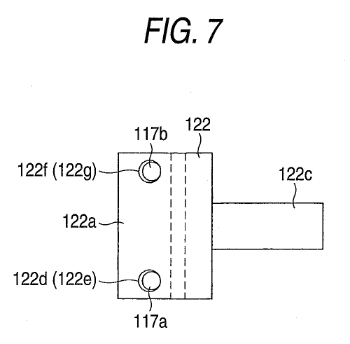

The mover 120 includes a permanent magnet 121 and a mover body 122 which supports the permanent magnet 121. Here, the permanent magnet 121 is a plastic magnet having the N-pole on the one-end portion 113a side of the fixed part body 110, and the S-pole on the other-end portion 113b thereof. The permanent magnet 121 generates a magnetic circuit 121a (refer to FIG. 6A) through the one-end portion 113a of the fixed part body 110, the orthogonal part 113c and the mover 120, and a magnetic circuit 121b (refer to FIG. 6B) through the other-end portion 113b of the fixed part body 110, the orthogonal part 113c and the mover 120, thereby to generate magnetic forces between the one-end portion and the other-end portion, and the mover. More specifically, the mover 120 is urged to the end portion closer to the mover 120, of the one-end portion 113a and the other-end portion 113b of the fixed part body 110. Further, the mover body 122 fixes the permanent magnet 121 in a position where the one-end portion 113a and the other-end portion 113b of the fixed part body 110, and the permanent magnet 121 are always in non-contact, and the mover body 122 is formed of non-magnetic material. Further, the mover body 122 includes an one-end side protrusion 122a which is arranged in the direction of the arrow 101a in relation to the permanent magnet 121 and functions as a gap forming part which forms a gap 120A with the permanent magnet 121; an other-end side protrusion 122b which is arranged in the direction of the arrow 101b in relation to the permanent magnet 121 and functions as a gap forming part which forms a gap 120B with the permanent magnet 121; and an optical element attachment part 122c which protrudes in order to attach the movable mirror 32 thereto. Further, the mover body 122 has hole portions 122d, 122e (refer to FIG. 7) into which the pillar 117a of the fixed part body 110 is inserted, and which function as a slide part which slides in relation to the pillar 117a; and hole portions 122f, 122g (refer to FIG. 7) into which the pillar 117b of the fixed part body 110 is inserted, and which function as a slide part which slides in relation to the pillar 117b. Here, the hole portions 122d and 122f are provided in the one-end side protrusion 122a, and the hole portions 122e and 122g are provided in the other-end side protrusion 122b.

Next, the operation of the optical switch 10 will be described.

When the movable mirror 32 is moved by the actuator unit 100 and enters the state shown in FIG. 1A, the light inputted from the outside to the optical fiber 21, after being outputted from the lens 22, being reflected by the fixed mirror 31 and the movable mirror 32, and impinging on the lens 23, is output from the optical fiber 24 to the outside. Further, when the movable mirror 32 is moved by the actuator unit 100 and enters the state shown in FIG. 1B, the light inputted from the outside to the optical fiber 21, after being outputted from the lens 22, being reflected by the fixed mirror 31 and the fixed mirror 33, and impinging on the lens 25, is output from the optical fiber 26 to the outside. Namely, the optical switch 10 can switch the optical path according to the operation of the actuator unit 100.

The operation of the actuator unit 100 will be described below in detail.

When the predetermined voltage is applied to the electromagnet 118 and each magnetic polarity of the one-end portion 113a and the other-end portion 113b of the E-shaped yoke 113 becomes the S-pole, and magnetic polarity of the orthogonal part 113c becomes the N-pole, magnetic attraction force is produced between the permanent magnet 121 of the mover 120 and the one-end portion 113a of the E-shaped yoke 113, and magnetic repulsion force is produced between the permanent magnet 121 of the mover 120 and the other-end portion 113b of the E-shaped yoke 113. Therefore, the mover 120 moves in the direction shown by the arrow 101a. When the permanent magnet 121 of the mover 120 is located closer to the one-end portion 113a of the E-shaped yoke 113 than to the other-end portion 113b thereof, the magnetic circuit 121a as shown in FIG. 6A is generated by the permanent magnet 121. Accordingly, in the state where the permanent magnet 121 of the mover 120 is located closer to the one-end portion 113a of the E-shaped yoke 113 than to the other-end portion 113b thereof, when application of the electric power to the electromagnet 118 is stopped, the mover 120 is pressed against the one-end portion 113a of the E-shaped yoke 113 by the magnetic attraction force between the permanent magnet 121 and the one-end portion 113a of the E-shaped yoke 113 (first magnetic attraction force acting in the moving direction of the mover), so that the mover 120 is kept in the contact state with the one-end portion 1133a.

When the voltage in the opposite direction to the direction of the predetermined voltage is applied to the electromagnet 118 and each magnetic polarity of the one-end portion 113a and the other-end portion 113b become the N-pole, and magnetic polarity of the orthogonal part 113c becomes the S-pole, magnetic repulsion force is produced between the permanent magnet 121 of the mover 120 and the one-end portion 113a of the E-shaped yoke 113, and magnetic attraction force is produced between the permanent magnet 121 of the mover 120 and the other-end portion 113b of the E-shaped yoke 113. Therefore, the mover 120 moves in the direction shown by the arrow 101b. When the permanent magnet 121 of the mover 120 is located closer to the other-end portion 113b of the E-shaped yoke 113 than to the one-end portion 113a thereof, the magnetic circuit 121b as shown in FIG. 6B is generated by the permanent magnet 121. Accordingly, in the state where the permanent magnet 121 of the mover 120 is located closer to the other-end portion 113a of the E-shaped yoke 113 than to the one-end portion 113b thereof, when application of the electric power to the electromagnet 118 is stopped, the mover 120 is pressed against the other-end portion 113b of the E-shaped yoke 113 by the magnetic attraction force between the permanent magnet 121 and the other-end portion 113b of the E-shaped yoke 113 (first magnetic attraction force acting in the moving direction of the mover), so that the mover 120 is kept in the contact state with the other-end portion 113b.

Here, magnetic attraction force (second magnetic attraction force acting in the direction orthogonal to the moving direction of the mover) is produced between the permanent magnet 121 of the mover 120 and the orthogonal part 113c of the E-shaped yoke 113 as shown in FIGS. 6A and 6B. Therefore, the mover 120 is always pressed against the pillars 117a and 117b in the direction of the arrow 101c, and the position of the mover 120 in the direction of the arrow 101c in relation to the pillars 117a and 117b is specified. Accordingly, even in case that each hole diameter of the holes 122d to 122g of the mover body 122 is set, as shown in FIG. 7, further larger than each diameter of the pillars 117a and 117b (for example, by 5% or more) so that the mover 120 can move smoothly while being guided by the pillars 117a, 117b, mechanical play is not produced between the mover 120 and the pillars 117a, 117b.

The mover 120 moves from the position where it comes into contact with one of the one-end portion 113a and the other end portion 113b of the E-shaped yoke 113 to the position where it comes into contact with the other of the one-end portion 113a and the other-end portion 113b, in a short time such as 10 msec. or less. The actuator unit 100, when the mover 120 does not move in relation to the fixed part body 110, is not necessary to receive the electric power by the electromagnet 118. Therefore, as long as the mover 120 can move in relation to the fixed part body 110 in a short time, the power-applied time can be reduced, so that the electric power is saved.

As described above, the actuator unit 100, since the fixed part body 110 and the mover 120 are integrated, can be mounted readily, and can prevent change in performance due to mount. Accordingly, the optical switch 10 can facilitate assembly and can prevent change in performance due to the assembly.

Further, in the actuator unit 100, the guide part is constituted by the two pillars 117a and 117b which extend in the moving direction of the mover 120 and are parallel to each other. These two pillars 117a and 117b are provided so as to be arranged on an imaginary plane orthogonal to the direction of the second magnetic attraction force produced between the mover 120 and the orthogonal part 113c. By action of the second magnetic attraction force, the holes 122d and 122e of the mover 120 are pressed against one pillar 117a, and the holes 122f and 122g of the mover 120 are pressed against the other pillars 117a and 117b. Further, the actuator unit 100 is so constituted that the contact portion of the holes 122d and 122e with the pillar 117a by this press, and the contact portion of the holes 122f and 122g with the pillar 117b by this press are accommodated respectively in the same plane (that the contact portions are accommodated respectively in a plane orthogonal to the direction of the second magnetic attraction force). Namely, the actuator unit 100 is so constituted that imaginary lines connecting the respective contact portions between each hole 122d to 122g and each pillar 117a, 117b form a plane. Accordingly, it is possible to suppress a tilt of the mover 120 in the direction orthogonal to the second magnetic attraction force.

Further, the mover 120, when it is located at one end in its moving range, comes into surface-contact with the one-end portion 113a of the fixed part body 110, and is pressed against its one-end portion 113a by the first magnetic attraction force acting in the moving direction of the mover 120, whereby rotation of the mover 120 around an axis extending in parallel to the direction of the second magnetic attraction force is suppressed.

By these first and second magnetic attraction forces in the orthogonal directions to each other, the posture of the mover 120 is specified. Such the posture specification of the mover 120 is required when the mover 120 is located at one end in its moving range, and the movable mirror 32 fixed to this mover 120 is arranged in the optical path switching position. In this embodiment, when the mover 120 is located at the other end in its moving range, since the movable mirror 32 is in a state where it is arranged out of the optical path, the posture specification of the mover 120 is not required basically. However, in another embodiment, in case that the movable mirror 32 is used as another optical path switching position when the mover 120 is located at the other end in its moving range, the posture of this mover 120 located on the other end side can be also specified by the same means as the means in the case when the mover 120 is located on the one-end side.

Further, since the pillars 117a and 117b are fixed directly to the one-end portion 113a and the other-end portion 113b of the E-shaped yoke 113, compared with the case where a special member for fixing the pillars 117a and 117b to the one-end portion 113a and the other-end portion 113b is provided, the manufacturing cost can be reduced and miniaturization of the actuator unit is possible.

Further, since the mover 120 has the plastic magnet as the permanent magnet 121, compared with the case where a sintered magnet is used as the permanent magnet 121, the mover 120 is lightweight. Accordingly, the mover 120, even in case that the force of gravity works in any direction, operates stably, and can exhibit the stable performance regardless of the mounted posture. Further, since the plastic magnet has high vibration shock-resistance due to resin material such as nylon functioning as a binder, it is suitable as the permanent magnet 121 provided for the mover 120.

Further, the mover body 122 that is another portion than the permanent magnet 121 of the mover 120 is formed of non-magnetic material. Hereby, in the actuator unit 100, compared with the case where the mover body 122 is formed of magnetic material, the weight of the mover 120 can be further reduced. In case that the mover body 122 is formed of magnetic material, compared with the case where the mover body 122 is formed of non-magnetic material, the magnetic force generated between the fixed part body 110 and the mover body 122 by the permanent magnet 121 can be made large. Accordingly, the force by which the mover 120 is fixed to the fixed part body 110 when the electric power is not applied to the electromagnet 118 can be made large. Hereby, the actuator unit 100, since the permanent magnet 121 may be small, can be miniaturized.

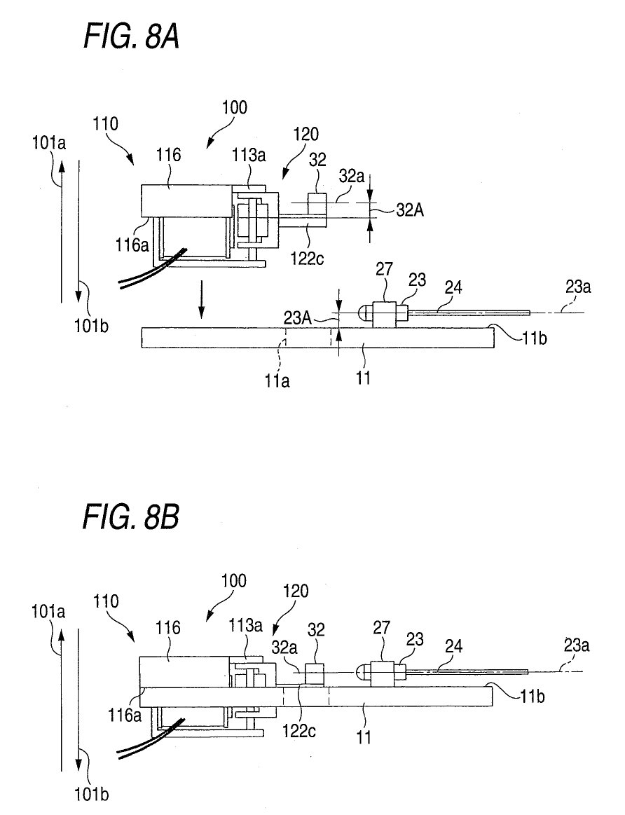

Further, since the mover 120 has the optical element attachment part 122c, the movable mirror 32 can be readily fixed to the mover 120 with good accuracy. Further, since the fixed part body 110 has the flange 116, it can be readily fixed to the platform 11 with good accuracy. Accordingly, in the actuator unit 100, as shown in FIG. 8A, it is good that the lengths in the direction shown by the arrow 101a of the optical element attachment part 122c and the flange 116 are set so that a distance 32A between an engagement surface 116a of the flange 116 with the platform 11 and an optical axis 32a of the movable mirror 32 when the mover 120 comes into contact with the one-end portion 113a of the fixed part body 110 becomes the same as a distance 23A between an engagement surface 11b of the platform 11 with the flange 116 and an optical axis 23a of the lens 23. Hereby, by only fixing the actuator unit 100 onto the platform 11, without special adjustment, the optical axis 32a of the movable mirror 32 and the optical axis 23a of the lens 23 can be aligned accurately as shown in FIG. 8B. In FIGS. 8A and 8B, illustration of the optical fiber 21, the lens 22 and the fixed mirror 31 is omitted.

Further, in the actuator unit 100, the gap 120A is formed between the permanent magnet 121 and the one-end side protrusion 122a of the mover body 122, and the gap 120B is formed between the permanent magnet 121 and the other-end side protrusion 122b of the mover body 122, whereby the permanent magnet 121 of the mover 120 is arranged in the position where it is always in non-contact with the one-end portion 113a of the fixed part body 110 and the other-end portion 113b thereof. Further, the position of each hole portion 122d to 122g of the mover 120 in relation to each pillar 117a, 117b of the fixed part body 110 is set so that the gap 120C is formed between the permanent magnet 121 and the orthogonal part 113C of the fixed part body 110. Hereby, compared with the constitution in which the permanent magnet 121 is arranged in a contactable position with the E-shaped yoke 113 of the fixed part body 110, the magnetic force (first magnetic attraction force and second magnetic attraction force) generated between the fixed part body 110 and the mover 120 by the permanent magnet 121 can be reduced, and the force by which the mover 120 is fixed to the fixed part body 110 when the electric power is not applied to the electromagnet 118 can be reduced. Accordingly, the actuator unit 100 can reduce the voltage which needs to be applied to the electromagnet 118 when the mover 120 moves in relation to the fixed part body 110. The sizes of these gaps 120A, 120B and 120C between the permanent magnet 121 and the E-shaped yoke 113 of the fixed part body 110 can be adjusted appropriately by the magnitude of the magnetic force of the permanent magnet 121 or magnet motive force of the electromagnet 118, or the magnitude of frictional resistance to the movement of the mover 120.

The pillars 117a, 117b are formed of non-magnetic material. Accordingly, it is possible to restrain the magnetic circuit of the permanent magnet 121 through these pillars 117a and 117b from being generated. Naturally, the pillars 117a, 117b may be formed of magnetic material. In case that the pillars 117a, 118b are formed of magnetic material, since the magnetic circuit of the permanent magnet 121 through the pillars 117a, 117b is generated in the actuator unit 100, the magnetic force generated by the magnetic circuit 121a or 121b can be adjusted by the thickness and the shape of the pillar 117a, 117b, or adjustment of material thereof. Further, in case that the pillar 117a, 117b is formed of magnetic material, the pillar 117a, 117b in the actuator unit 100 can be formed of iron-based material which is cheaper than ceramics. Therefore, the manufacturing cost can be reduced.

Of the surface portion in which pillar 117a, 117b and the hole portion 122d, 122e come into contact with each other, at least one member may be formed of solid lubricant. According to this constitution, the mover 120 can exhibits the stable performance for a long period. Here, since the solid lubricant does not make an optical element such as a prism or a mirror dirty, which is different from the case of wet lubricant using lubricative oil or the like. Therefore, the solid lubricant is suited to an optical device such as an optical switch. As methods of forming the surface portion of the member, of the solid lubricant, there are a method of applying to the surface portion coating of the solid lubricant such as fluoric coating or molybdenum disulfide coating, and a method of forming the member itself of the solid lubricant.

Further, regarding the surface portions in which the one-end portion 113a and the other-end portion 113b of the fixed part body 110, and the one-end side protrusion 122a and the other-end side protrusion 122b of the mover 120 come into contact with each other, at least one of the fixed part body 110 and the mover 120 may be formed of the solid lubricant. According to this constitution, it is possible to prevent the mover 120 and the fixed part body 110 from adhering to each other. For example, even after the actuator unit has been left for a long period such as several months and more, the mover 120 can be operate stably.

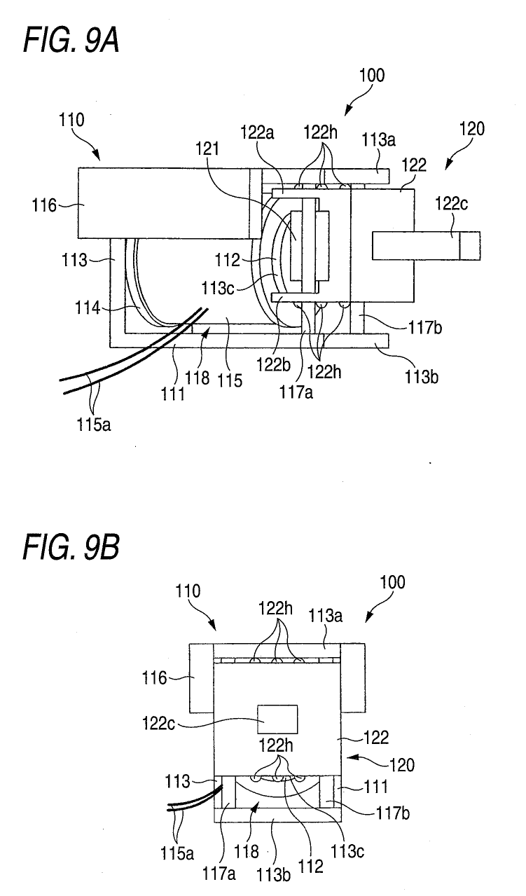

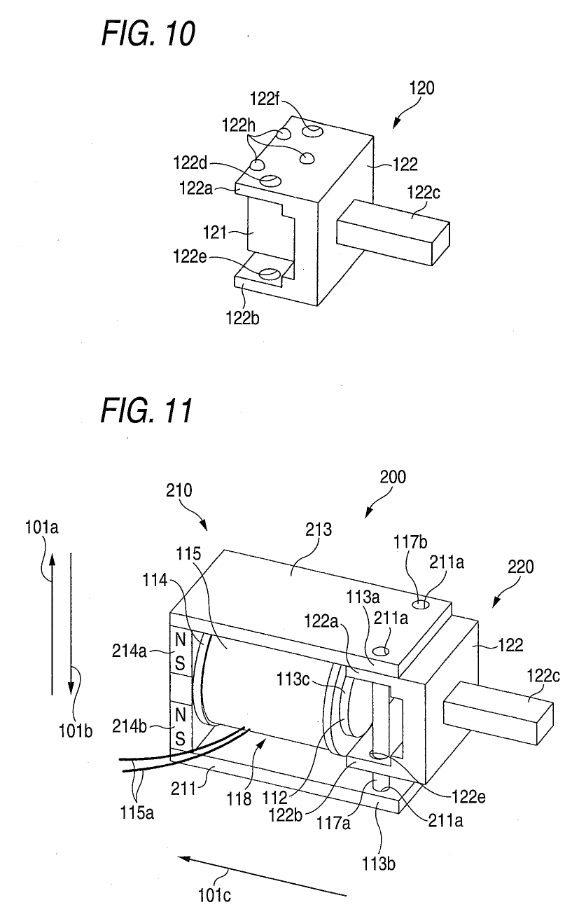

Further, as shown in FIGS. 9A and 9B, the contact portion of the one-end side protrusion of the mover 120 with the one-end portion 113a of the fixed part body 110 may be formed by a projection 122h. According to this constitution, since the portion in which the mover 120 and the fixed part body 110 come into contact with each other is small in contact area, adhesion can be prevented. For example, even after the actuator unit has been left for a long period such as several months and more, the mover 120 can be operate stably. Further, in case that the projection 122h is formed of the solid lubricant, even after the actuator unit has been left for a longer period, the mover 120 can exhibit the stable performance. This projection 122 is composed of three or more projections which do not exist on the same line as shown in FIG. 10, whereby the posture of the mover 120 in relation to the fixed part body 110 when the one-end side protrusion 122a comes into contact with the one-end portion 133a is stabilized. Naturally, such the projection 122 can be provided on the one-end portion 113a side of the fixed part body 110. Further, the projection 122 can be provided similarly for the other-end side protrusion 122b of the mover 120 or the other-end portion 113b of the fixed part body 110.

Although the above-mentioned optical switch 10 is a 1×2 optical switch, another switch (for example, 1×4 optical switch) than the 1×2 optical switch can be also constituted similarly by means of plural actuator units similar to the actuator unit 100.

### Second Embodiment

Next, the constitution of an optical switch according to a second embodiment will be described.

The similar components of an optical switch according to this embodiment to those of the optical switch 10 (refer to FIGS. 1A and 1B) according to the first embodiment are denoted by the same signs in the drawings and the detailed description of them is omitted.

The optical switch in this embodiment includes in its constitution an actuator unit 200 shown in FIG. 11, in place of the actuator unit 100 which drives the movable mirror 32 in the optical switch 10 shown in FIGS. 1A and 1B.

The actuator unit 200 includes in its constitution a fixed part body 210 and a mover 220 shown in FIG. 11, in place of the fixed part body 110 and the mover 120 in the actuator unit 100 shown in FIG. 2. Further, in the actuator unit 200, the fixed part body 210 and the mover 220 are integrated. Although the mover 120 has the permanent magnet 121 in the above actuator unit 100, the fixed part body 210 has permanent magnets 214a and 214b in this actuator unit 200.

The fixed part body 210 includes in its constitution an E-shaped yoke 213 to which the permanent magnets 214a and 214b are fixed, in place of the E-shaped yoke 113 and the flange 116 shown in FIG. 2. This E-shaped yoke 213 includes a C-shaped member 211 formed of iron (magnetic material) and an iron core 112 fixed to the C-shaped member 211. Here, pillars 117a and 117b are inserted into holes 211a formed in one end portion 113a and the other end portion 113b of the fixed part body 210 thereby to be fixed to the fixed part body 210. Further, in the permanent magnets 214a and 214b, each of their magnetic polarities on the one-end portion 113a side of the fixed part body 210 is the N-pole, and that on other-end portion 113b side thereof is the S-pole. The permanent magnets 214a and 214b generate magnetic forces between the one-end portion 113a and the other-end portion 113b, and the mover 220.

The mover 220 is formed of magnetic material. The shape of this mover 220 is nearly the same as the shape in which the permanent magnet 121 is removed from the mover 120 shown in FIG. 2.

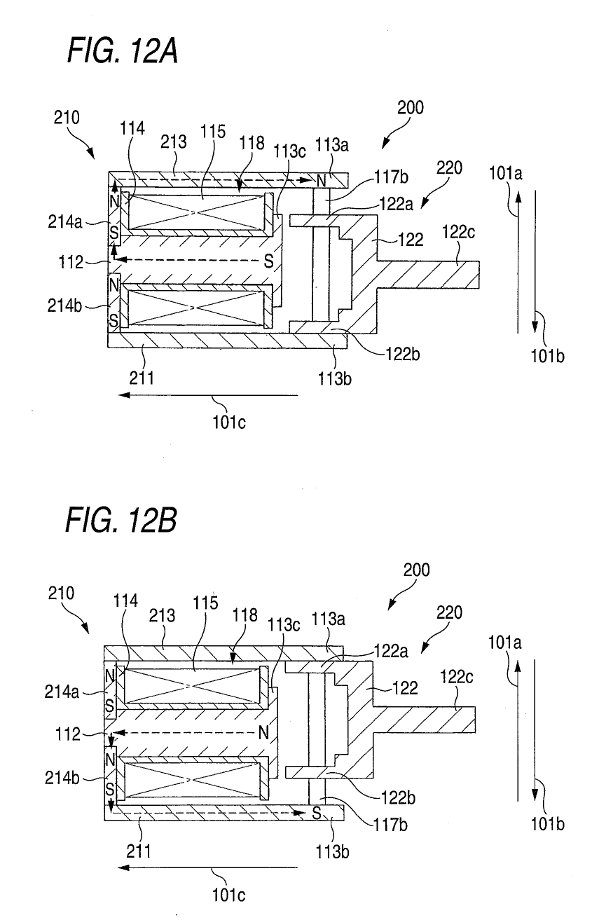

Next, the operation of the actuator unit 200 will be described. The one-end portion 113a of the E-shaped yoke 213 is the N-pole side of the permanent magnets 214a and 214b, and the other-end portion 113b thereof is the S-pole side of the permanent magnets 214a and 214b. When a predetermined voltage is applied to an electromagnet 118 so that the magnetic polarity of the other-end portion 113b almost disappears, as shown in FIG. 12A, the magnetic polarity of the one-end portion 113a becomes is the N-pole which is larger in magnetic force than the other-end portion 113b, and the magnetic polarity of an orthogonal part 113c becomes the S-pole. As the magnetic force of the one-end portion 113a becomes larger than that of the other-end portion 113b, magnetic attraction force between the one-end portion 113a and the mover 220 becomes larger than magnetic attraction force between the other-end portion 113b and the mover 220, so that the mover 220 moves in the direction shown by an arrow 101a. Since the one-end portion 113a of the E-shaped yoke 213 is magnetized by the permanent magnets 214a and 214b, when application of electric power to the electromagnet 118 is stopped in a state where the mover 220 is located closer to the one-end portion 113a than to the other-end portion 113b of the E-shaped yoke 213, the mover 220 is kept in a contact state with the one0end portion 113a of the E-shaped yoke 213 by the magnetic attraction force (first magnetic attraction force acting in the moving direction of the mover) between the one-end portion 113a of the E-shaped yoke 213 and the mover 220.

Further, when a predetermined voltage is applied to the electromagnet 118 so that the magnetic polarity of the one-end portion 113a almost disappears, as shown in FIG. 12B, the magnetic polarity of the other-end portion 113b becomes the S-pole which is larger in magnetic force than the one-end portion 113a, and the magnetic polarity of the orthogonal part 113c becomes the N-pole. As the magnetic force of the other-end portion 113b becomes larger than that of the one-end portion 113a, magnetic attraction force between the other-end portion 113b and the mover 220 becomes larger than magnetic attraction force between the one-end portion 113a and the mover 220, so that the mover 220 moves in the direction shown by an arrow 101b. Since the other-end portion 113b of the E-shaped yoke 213 is magnetized by the permanent magnets 214a and 214b, when application of electric power to the electromagnet 118 is stopped in a state where the mover 220 is located closer to the other-end portion 113b than to the one-end portion 113a of the E-shaped yoke 213, the mover 220 is kept in a contact state with the other-end portion 113b of the E-shaped yoke 213 by the magnetic attraction force (first magnetic attraction force acting in the moving direction of the mover) between the other-end portion 113b of the E-shaped yoke 213 and the mover 220.

Here, when the electric power is applied to the electromagnet 118 and the orthogonal portion 113c of the E-shaped yoke 213 is magnetized by the electromagnet 118 as shown in FIGS. 12A and 12B, since magnetic attraction force (second magnetic attraction force acting in the direction orthogonal to the moving direction of the mover) is produced between the mover 220 and the orthogonal part 113c, the mover 220 is pressed against the pillars 117a and 117b in the direction shown by an arrow 101c, and positioning of the mover 220 in relation to the pillars 117a and 117b in the direction of the arrow 101c is stabilized.

As described above, in the constitution of the actuator unit 200, only the fixed part body 210 of the fixed part body 210 and the mover 220 has the permanent magnets 214a and 214b. Accordingly, the actuator unit 200, compared with the case where the mover 220 has the permanent magnet like the actuator unit 100 (refer to FIG. 2) according to the first embodiment, since the mover 220 is lightweight, and operates stably even in case that the force of gravity works in any direction, can exhibit stable performance regardless of the mounted posture.

### Third Embodiment

Sequentially, the constitution of an optical switch according to a third embodiment will be described.

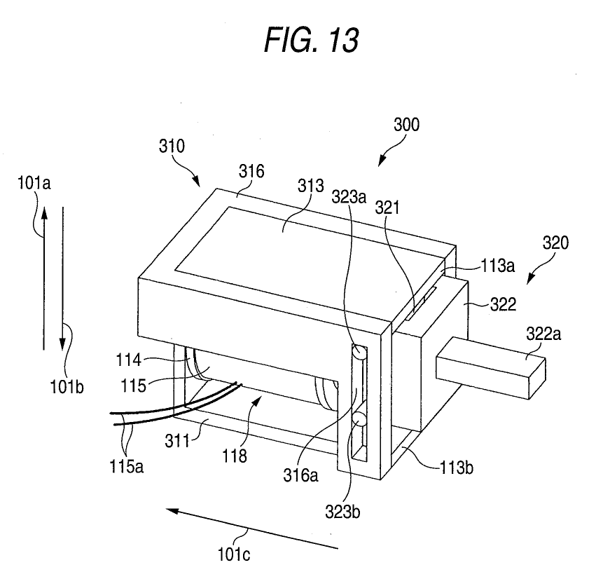

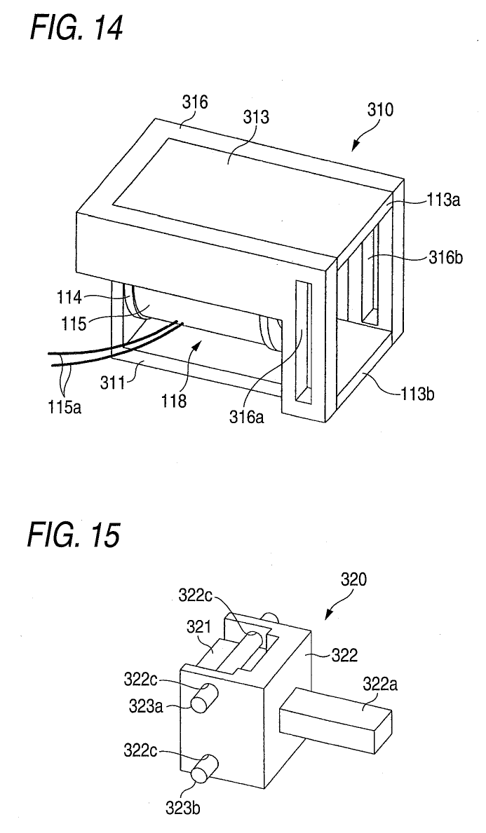

The similar components of an optical switch according to this embodiment to those of the optical switch 10 (refer to FIGS. 1A and 1B) according to the first embodiment are denoted by the same signs in the drawings and the detailed description of them is omitted. The optical switch in this embodiment includes in its constitution an actuator unit 300 shown in FIGS. 13 to 15, in place of the actuator unit 100 which drives the movable mirror 32 in the optical switch 10 shown in FIGS. 1A and 1B.

The actuator unit 300 includes in its constitution a fixed part body 310 and a mover 320 shown in FIG. 13, in place of the fixed part body 110 and the mover 120 in the actuator unit 100 shown in FIG. 2. Further, in the actuator unit 300, the fixed part body 310 and the mover 320 are integrated.

The fixed part body 310 includes in its constitution an E-shaped yoke 313 and a flange 316, in place of the E-shaped yoke 113, the flange 116, and the pillars 117a, 117b shown in FIG. 2. The E-shaped yoke 313 includes a C-shaped member 311 formed of iron (magnetic material) and an iron core 112 (not shown) fixed to the C-shaped member 311. The flange 316 is fixed to this E-shaped yoke 313, and has elongated hole portions 316a, 316b which function as positioning members when the fixed part body 310 is fixed onto a platform 11, and extend, as a guide member for guiding movement of the mover 320, in the moving direction of the mover 320 (direction shown by an arrow 101a).

The mover 320 has a permanent magnet 321, a mover body 322 which supports the permanent magnet 321, and two pillars 323a and 323b which are inserted into the elongated hole portions 316a and 316b of the fixed part body 310 and function as sliding parts which slide in the elongated hole portions 316a and 316b. Here, in the permanent magnet 321, magnetic polarity on the one-end portion 113a side of the fixed part body 310 is the N-pole, and magnetic polarity on the other-end portion 113b side is the S-pole. The permanent magnet 321 urges the mover 320 to the portion closer to the mover 320, of the one-end portion 113a and the other-end portion 113b of the fixed part body 310. Further, the mover body 322 fixes the permanent magnet 321 in a position where the one-end portion 113a and the other-end portion 113b of the fixed part body 310, and the permanent magnet 321 are always in non-contact, and the mover body 322 is formed of non-magnetic material. Further, the mover body 322 has an optical element attachment part 322a protruding in order to attach a mover mirror 32 thereto. Further, the pillars 323a and 323b extend in parallel to each other in the direction orthogonal to the moving directions of the mover 320 (directions shown by arrows 101a and 101c), and they are made of non-magnetic material such as ceramic material, for example, alumina, zirconia, or the like. These pillars 323a and 323b are inserted respectively into plural holes 322c formed in the mover body 322 thereby to be fixed to the mover body 322.

The actuator unit 300 operates similarly to the actuator unit 100 according to the first embodiment.

As described above, the actuator unit 300 is so constituted that the pillars 323a and 323b are pressed against both of the elongated hole portions 316a and 316b by second magnetic attraction force produced between the mover 320 and an orthogonal part 113c (not shown in FIG. 13) of the fixed body part 310. Further, the actuator unit 300 is so constituted that the respective contact portions between the pillars 323a, 323b and the elongated hole portions 316a, 316b made by this pressing are accommodated in the same plane. Hereby, it is possible to suppress a tilt of the mover 320 in the direction orthogonal to the second magnetic attraction force.

In the above-mentioned embodiments, the examples in which the actuator unit according to the invention is applied to the optical switch have been described. However, the actuator unit according to the invention can be also applied to other optical devices (for example, an optical shutter, a variable optical attenuator, a variable wavelength filter device, a variable wavelength dispersion guaranty device, an optical part tester, and the like) than the optical switch. Also when the actuator unit of the invention is applied to other optical devices than the optical switch, the similar effects to those when the actuator unit of the invention is applied to the optical switch can be obtained

### INDUSTRIAL APPLICABILITY

As described above, the actuator unit according to the invention has an advantage that the tilt of the mover can be suppressed by specifying the posture of the moved mover, and this actuator unit is useful as an actuator for optical communication system.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. An actuator unit which moves an optical-reflection element in relation to an optical path of a light signal in order to switch the optical path, comprising:
a mover to which the light reflection element is fixed, and
a fixed part body which supports the mover movably, wherein the fixed part body has an E-shaped yoke including one end portion arranged on one end side in a moving range of the mover, the other portion arranged on the other end side in the moving range, and an orthogonal part arranged between the one-end portion and the other-end portion and in a direction nearly orthogonal to the moving direction of the mover;
an electromagnet for magnetizing the one-end portion and the other-end portion of the E-shaped yoke, and the orthogonal part with opposite polarities to each other; and
a guide part for guiding a movement in the moving range of the mover,
the mover has a slide part for sliding the guide part of the fixed part body, and
at least one of the fixed part body and the mover has a permanent magnet which generates magnetic force between the one-end portion and the other-end portion of the fixed part body, and the mover,
when the mover is located at the one-end portion in the moving range, said actuator unit is pressed to the one-end portion by first magnetic attraction force generated by the permanent magnet between the mover and the one-end portion, and the slide part is pressed against the guide part of the fixed part body by second magnetic attraction force generated by the permanent magnet or the electromagnet between the mover and the orthogonal part.

2. The actuator unit according to claim 1, wherein the slide part of the mover is constituted so that: when the slide part of the mover is pressed against the guide part of the fixed part body by the second magnetic attraction force, an imaginary line connecting contact portions of the slide part with the guide part forms a plane.

3. The actuator unit according to claim 2, wherein:
the guide part of the fixed part body extends in the moving direction of the mover thereby to be fixed to the one-end portion and the other-end portion of the fixed part body, and is provided in two places so as to be arranged on an imaginary plane orthogonal to the direction of the second magnetic attraction force; and
the slide part of the mover is provided so as to correspond to the guide part located at two places thereof, and pressed by the second magnetic attraction force against the both guide parts located at the two places so as to come into contact with the guide parts.

4. The actuator unit according to claim 1, wherein the mover has the permanent magnet, and the permanent magnet provided for the mover generates second magnetic attraction force between the orthogonal part and the mover.

5. The actuator unit according to claim 4, wherein the mover is so constituted so as to form a gap between the permanent magnet and the orthogonal part of the fixed part body in a state where the slide part is pressed against the guide part of the fixed part body by the second magnetic attraction force; form a gap between the permanent magnet and the E-shaped yoke one-end portion of the fixed part body when the mover is located at one end in the moving range of the mover; and form a gap between the permanent magnet and the other-end portion of the fixed part body when the mover is located at the other end in the moving range of the mover.

6. The actuator unit according to claim 1, wherein at least one member of the contact portion between the fixed part body including the guide part and the mover including the slide part is formed of solid lubricant.
